(19) United States
(12) Patent Application Publication
(10) Pub. No.: US 2013/0322298 A1
(43) Pub. Date: Dec. 5, 2013

(54) Network Topology Discovery

(71) Applicants: William M. Alexander, JR., Redwood City, CA (US); Dhaval Shah, Cupertino, CA (US); William S. Gibson, Redwood city, CA (US)

(72) Inventors: William M. Alexander, JR., Redwood City, CA (US); Dhaval Shah, Cupertino, CA (US); William S. Gibson, Redwood city, CA (US)

(21) Appl. No.: 13/984,976

(22) PCT Filed: Oct. 11, 2011
(86) PCT No.: PCT/US2011/055749

§ 371 Date: Aug. 12, 2013

Related U.S. Application Data
(60) Provisional application No. 61/467,850, filed on Mar. 25, 2011.

(51) Int. Cl. H04L 12/24

(52) U.S. Cl. CPC H04L 41/12
USPC 370/255

(57) ABSTRACT

Topology discovery includes determining connection data identifying connections between network devices. The connection data includes the network devices and network interfaces for the devices, iterations are performed to determine links in the topology based on the connection data. An iteration may include adding a link in the topology (306), adding an unknown domain to the topology (501), or removing an interface associated with the added link from the connection data if the link is added to the topology (403).

### PRIORITY

The present application claims priority to U.S. provisional patent application Ser. No. 61/467,850, filed Mar. 25, 2011, and entitled “Network Topology Discovery”.

### BACKGROUND

For network administration or network planning, a map of the network infrastructure is typically created. The map identifies devices, such as routers, gateways, etc., in the network and connections between the devices. The map may identify the status of devices or connections, such as whether they are failed or operational, and may identify network metrics about the devices or connections.

In order to generate the map, the devices and their connections need to be discovered. Most Open Systems Interconnection (OSI) layer 2 devices, such as switches, use some variation of the Spanning Tree Protocol to determine which connections to use. As a result, the devices know which other layer 2 devices they connect to. Typically, a management system can poll the devices to find out about the connections they know about. This approach has the fairly obvious failing that only connections between devices supporting compatible versions of the Spanning Tree Protocol can be discovered.

Often, it is more difficult to discover layer 2 devices and their connections. For example, layer 2 connections may not be discoverable or may not be 100% accurate between neighboring devices that implement different (incompatible) layer 2 discovery protocols. A forwarding database for a bridge may be used to determine connections but the information may not be current or a forwarding database may not be available. Thus, it is often difficult to accurately identify devices and connections for a map.

### BRIEF DESCRIPTION OF DRAWINGS

The embodiments are described in detail in the following description with reference to the following figures:

FIG. 1 illustrates a system;

FIG. 2 illustrates an example of devices in a network;

FIG. 3 illustrates a flow chart;

FIG. 4 illustrates a flow chart;

FIG. 5 illustrates a flow chart;

FIG. 6 illustrates an example of IP devices in a network; and

FIG. 7 illustrates a computer system that may be used for the methods and systems described herein.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

A topology discovery process determines connections and unknown domains for a topology. In one embodiment, connections for all discovered devices are determined or all possible routes through the network are exhausted. Cached connection data may be used to determine connections and determine updates to the topology. A topology is a map of a network including devices in the network and connections between the devices. Once determined, the topology may be displayed on a user interface and can be used for network administration and planning.

The topology discovery process may include using cached connection data to identify multiple connections from a network interface on a device. However, these connections may not be direct connections. For example, the connections may comprise multi-hop connections between a network interface and another device. According to an embodiment, the topology discovery process identifies, from the connection data, connections comprised of direct bi-directional connections between network interfaces on two devices. The identified direct bi-directional connections, for example, are connections for a spanning tree. These connections are used to form the topology.

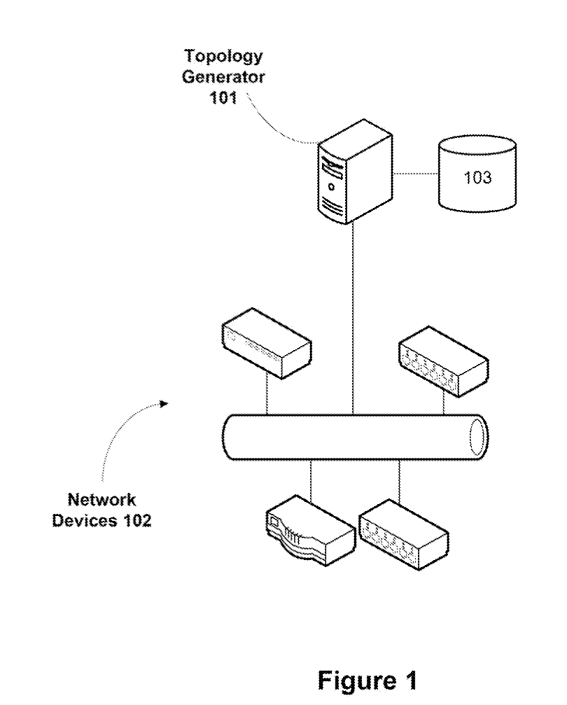

FIG. 1 illustrates a system 100 including a topology generator 101 that collects data from network devices 102. The network devices 102 may include layer 2 devices such as switches, layer 3 devices such as routers, or other network devices. End user devices may also be included. The topology generator 101 runs the topology discovery process and determines connections or unknown domains for a topology from connection data gathered from the network devices 102. The connection data may include data any data that can be used to determine links in the topology. The connection data may be gathered from Address Resolution Protocol (ARP) cache or Media Access Control (MAC) caches from the network devices 102. The connection data may include a list of interfaces on the device. The name of the interface and the MAC address of the interface if available may be included. The connection data may include names of interfaces as well as addresses such as MAC addresses, IP addresses or other types of addresses.

The topology generator 101 determines links in the topology of the network from the connection data. To determine the links, a list of connections is determined from the connection data. The connections represent candidate links and one or more of the connections may be selected as actual links in the topology through processing of the connection data. A connection or link is represented by a connection between a pair of network interfaces on different network devices. On the topology a line is drawn between the interfaces to show the link. A connection or link may be bi-directional. The connection or link is a direct connection without any intervening hops. The connection or link may be a connection in a spanning tree and there is one connection between two interfaces on two network devices. A network interface, also referred to herein as interface, may include hardware that takes information packaged by a network protocol and puts it into a format that can be transmitted over some physical medium like Ethernet, a fiber-optical cable, or wirelessly. A switch may include multiple interfaces for sending and receiving data over the network.

The topology generator 101 also identifies a list of unknown domains for which more information is needed. An unknown domain is a group of devices that the topology discovery process can determine are connected, but cannot determine the exact nature of the connection. For example, the process may not be able to determine if the group of devices are connected through single hop or multi hop connections, or cannot determine the interface for the connections, etc. An unknown domain might be represented on a map as a cloud connected to each of the devices in the list.

The topology discovery process is described in further detail below. The topology generator 101 stores topology data gathered from the network devices 102 in a data storage 103 that may be used to determine the topology.

The topology generator 101 may include machine readable instructions executed by a computer system to perform the topology discovery process. The topology generator 101 may include a central computer system, such as a server, capturing topology data to generate the topology or the topology generator 101 may be a distributed application running on multiple computer systems. The topology generator 101 may include an application running on a server in a distributed computing system, such as a cloud computing system, that generates a topology for a network.

The topology generator 101 polls network devices in a network for ARP cache and MAC cache data, and uses this information to determine the topology of the network. The ARP cache is a table which stores mappings between Data Link Layer addresses (e.g., MAC addresses) and Network Layer addresses (e.g., Internet Protocol (IP) addresses). The process iterates across the routers in the network. The links associated with a single router are calculated for devices within the routers domain. The domain shall include, for example, any network devices that could be put into the ARP cache of the discovered router. From time to time a new device shall be discovered, or a device shall be deleted. The process periodically checks for such changes, and when one is found, the process is run on the router that has the device in its domain. Examples for the discovery process are provided below followed by flowcharts describing the methods for the discovery process.

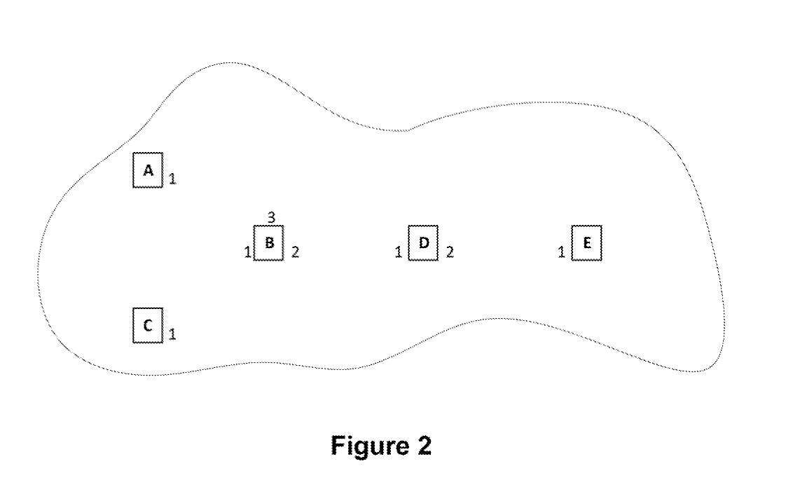

The following two examples describe the topology discovery process applied to a network. The examples discover connections between network devices shown in FIG. 2. Each box represents a network device. The letters in the boxes are the device names. The numbers next to the boxes represent interfaces. Interfaces are referred to as the device name followed by dash, followed by the interface number, e.g., D-2 is the second interface on switch D. The MAC Address for the interface is referred to as M.D-2, e.g., M followed by period, followed by the device name, followed by the interface number.

Some examples of virtual interfaces are included. Virtual interfaces are one way of segregating traffic out of a physical interface. The topology discovery process accounts for virtual interfaces because they may show up in interface lists, ARP caches, and MAC caches. D-2.1 is an example of name of a virtual interface which is the first virtual interface on interface 2 of device D. The MAC address of a virtual interface is that of its physical interface. For instance the MAC Address of D-2.1 is M.D-2.

Table 1 below is an example connection data including input data from caches, from which network connections are determined.

TABLE 1

| Device | Interface | MAC | Cache |
|---|---|---|---|
| A | A-1 | M.A-1 | M.C-1, M.D-1, M.E-1 |
| B | B-1 | ? | M.C-1 |
| | B-2 | ? | M.D-1, M.E-1 |
| | B-3 | ? | M.A-1 |
| C | C-1 | M.C-1 | M.A-1 |
| | C-1.2 | M.C-1 | M.D-1, M.E-1 |
| D | D-1 | M.D-1 | M.A-1 |
| | D-1.1 | M.D-1 | M.C-1 |
| | D-2 | M.D-2 | M.E-1 |
| E | E-1 | M.E-1 | M.A-1, M.D-2 |
| | E-1.1 | M.E-1 | M.C-1 |

B may be an older device, so MAC addresses for each interface are not available. Nevertheless, the topology is determined.

The first step is to determine the destinations which correspond to the cache entries. This may be done by adding a destination corresponding to each MAC address. Once the destinations are found, the cache entries are no longer needed.

TABLE 2

| Device | Interface | MAC | Destinations |
|---|---|---|---|
| A | A-1 | M.A-1 | C-1, D-1, E-1 |
| B | B-1 | ? | C-1 |
| | B-2 | ? | D-1, E-1 |
| | B-3 | ? | A-1 |
| C | C-1 | M.C-1 | A-1 |
| | C-1.2 | M.C-1 | D-1, E-1 |
| D | D-1 | M.D-1 | A-1 |
| | D-1.1 | M.D-1 | C-1 |
| | D-2 | M.D-2 | E-1 |
| E | E-1 | M.E-1 | A-1, D-2 |
| | E-1.1 | M.E-1 | C-1 |

Table 2 shows putting the inputs in standard form.

In this example, there are no destinations from a device to itself, so nothing to remove here. Destinations are added so each destination has a reverse destination. In this example, quite a few destinations are added to ensure that each destination has a reverse destination. The inputs, after making these changes are given in the table 3 below. Added destinations are indicated in bold.

TABLE 3

| Device | Interface | MAC | Destinations |
|---|---|---|---|
| A | A-1 | M.A-1 | B-3, C-1, D-1, E-1 |
| B | B-1 | ? | C-1 |
| | B-2 | ? | D-1, E-1 |
| | B-3 | ? | A-1 |
| C | C-1 | M.C-1 | A-1, B-1, D-1.1, E-1.1 |
| | C-1.1 | M.C-1 | D-1, E-1 |
| D | D-1 | M.D-1 | A-1, B-2, C-1.1 |
| | D-1.1 | M.D-1 | C-1 |
| | D-2 | M.D-2 | E-1 |
| E | E-1 | M.E-1 | A-1, B-2, C-1.1, D-2 |
| | E-1.1 | M.E-1 | C-1 |

At this point interfaces with duplicate MAC Addresses are removed. The general rule is to remove interfaces with names that sort alphabetically later. Interfaces with unknown MAC addresses are not removed. Typically virtual interfaces are named similarly to physical interfaces, such as a name consisting of the physical interface name, followed by a suffix of some sort. For this reason these come later in the alphabet, and are the interfaces that are removed. Any destinations on removed interfaces are moved to the interface with the same MAC Address which is kept. So, for instance C-1.1 is removed, and destination D-1 and E-1 is moved to C-1.

In addition, any destination which points to an interface to be removed is changed to point to an interface with the same MAC address which is being kept. So in the case of C, destinations D-1.1 and E-1.1 are changed to D-1 and E-1 respectively when interfaces D-1.1 and E-1.1 are removed. These same destinations were previously added and should not be added twice.

After removing interfaces with duplicate MAC Addresses, the table 4 shows the inputs. The MAC column, which is no longer needed, is not shown.

TABLE 4

| Device | Interface | Destinations |
|---|---|---|
| A | A-1 | B-3, C-1, D-1, E-1 |
| B | B-1 | C-1 |
| | B-2 | D-1, E-1 |
| | B-3 | A-1 |
| C | C-1 | A-1, B-1, D-1, E-1 |
| D | D-1 | A-1, B-2, C-1 |
| | D-2 | E-1 |
| E | E-1 | A-1, B-2, C-1, D-2 |

Each device has at most one destination on each other device. No change is needed to meet this requirement. All interfaces have destinations, and thus no changes are needed. The connection data shown in Table 4 represents connections between network interfaces in network devices. Through processing described in further detail below, links in the topology may be determined from the connections.

Given below are the inputs in normal form, and a map of the devices, with no connections and domains. With each iteration the process adds a connection or unknown domain, and/or removes a destination and/or an interface.

### Iteration 1

In each iteration the process looks for the interface with the fewest destinations. For the first iteration either B-1, B-3, or D-2 could have been selected. As a rule the first interface found (top to bottom) is used; in this case SELECTED=B-1. Then a link is added from B-1 to C-1. The first iteration can be represented as follows:

### SELECTED=B-1

### REVERSE=C-1

### BEGIN=B

### END=C

The first interface found is SELECTED. The destination interface for SELECTED is REVERSE. The SELECTED device is BEGIN, and the REVERSE device is END, Destinations A-1, B-1, D-1, and E-1 are removed from C-1, and the corresponding reverse links. In addition, interfaces B-1 and C-1 are removed. The result is as follows, removed items indicated by strike-through.

TABLE 5

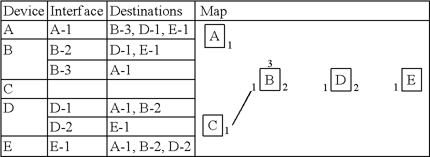

### Iteration 2

The interface with the fewest number of destinations is B-3. Add a link from B-3 to A-1. That gives

### SELECTED=B-3

### REVERSE A-1

### BEGIN=B

### END=A

Remove destinations B-3, D-1, and E-1 from A-1, as well as the reverse destinations. In addition, remove interfaces A-1 and B-3. The result is:

TABLE 6

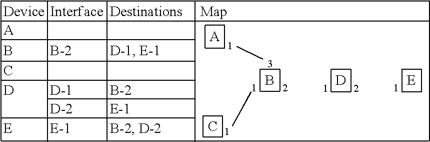

### Iteration 3

D-1 has one destination. Create a link from D-1 to B-2.

### SELECTED=D-1

### RREVERSE=B-2

### BEGIN=D

### END=B

Remove the destinations on B-2, and remove B-2 and D-1. The result is:

TABLE 7

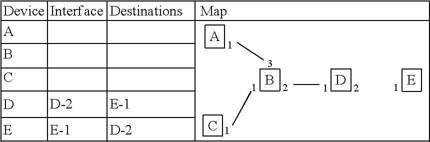

### Iteration 4

D-2 has one destination. Create a link from D-2 to E-1.

### SELECTED=D-2

### REVERSE=E-1

### BEGIN=D

### END=E

Remove destinations on E-1 and remove E-1 and D-2. This yields:

TABLE 8

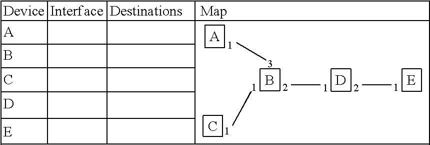

At this point there are no interfaces left, so the process terminates. The result is a spanning tree, as desired.

The second example has some information missing, and the result is an unknown domain. Consider the same network as above, and the same cache data, except that device B information is missing. If the inputs are put into standard form, the following data for the calculation phase is determined:

TABLE 9

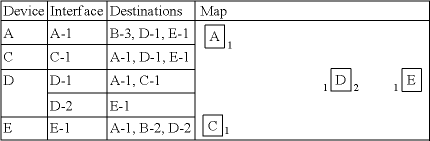

### Iteration 1

D-2 has one destination. Create a link from D-2 to E-1.

### SELECTED=D-2

### REVERSE=E-1

### BEGIN=D

### END=E

Remove destinations on E-1 and remove E-1 and D-2. This yields:

TABLE 10

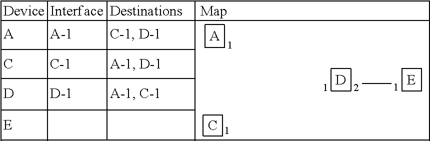

### Iteration 2

All remaining interfaces have two destinations. Pick the device containing A-1, and the devices containing destinations of A-1 (namely C and D), and connect them with an unknown domain. Remove all destinations on interfaces on A, C, and D. The result is:

TABLE 11

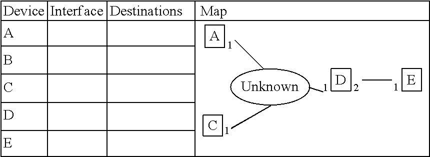

There are no destinations left, so the topology discovery process terminates.

Both ARP and MAC caches are typically real caches; their contents can age out and be removed over time if no traffic to the specified MAC address is received. To ensure that the caches contain the necessary data, some traffic may be sent to each of the devices (e.g. ping them) to make sure that their caches contain the needed information. Data collection for collecting the connection data may include polling for the appropriate data, using any appropriate management interface.

The following data structures containing the inputs are defined to allow a clear and precise definition of the topology discovery process. Other data structures may be used. The data structures are presented in a Java like pseudo-code. The inputs consist of a Collection<Device>object. Collection indicates a generic list, and the name in the angle brackets indicates the type of the object in the collection—in this case Devices.

Instances of the Interface class contain information about a single interface, and its connection to others.

```
Class Interface {
  String name; // Interface name
  Address address; // Address of interface
  Device device; // device containing this interface
  // reachable addresses
  Collection<Address> addresses;
  // reachable destinations
  Collection<Interface> destinations;
}
```

Instances of the Device class contain a collection of Interfaces, and in practical applications, other information,

Class Device {
Collection<Interface> interfaces; // on this device
}

The inputs can be used to populate a list of devices, each device with a list of interfaces, and the addresses populated from the address caches. The destinations are then populated by creating a Map (index) of addresses to interfaces, and for each address in the addresses, finding the corresponding interface.

Connection data may be standardized and normalized for the topology discovery process. Examples of standardizing and normalizing is described above with respect to tables 1 through 4. For standardizing, the following conditions may be met. Firstly, if interface B is in the destinations of interface A, then interface A must be in the destinations of interface B. In other words—two way communication. Secondly, two interfaces on the same device should not have the same address. Sometimes the raw output from a device shows two interfaces with the same MAC address. This is typically because some of the interfaces are “virtual interfaces”. Virtual interface names are typically the physical interface name plus some additional characters. For instance, if “i1” is a physical interface, “i1-1” and “i1-2” are most likely virtual interfaces. One way to select a single interface if more than one have the same address is to pick the first one in alphabetical order, since that is normally the physical interface. Thirdly, for any two devices A and B, there should be at most one interface on A that has an interface on B as a destination (unique interface per destination).

The next section describes how to convert an arbitrary collection of devices into one that meets the above conditions.

The following may be performed to normalize connection data. For each device, remove any destinations that are to interfaces on the same device. Connections between a device and itself are not calculated. Also, for each device, check all the destinations on its interfaces. If interface A has a destination interface B, and A is not a destination interface for B, add A as a destination interface. Also, for each device, check to see that each interface on this device has a different address. If two interfaces A and B are found with the same address, find the interface that has the name last in alphabetical order (assume this is B). Then add all destinations of B to A's destinations, and modify all the destinations that go to B to instead go to A. Then remove interface B.

Also, for each device A and B, find all destinations to B on interfaces on A. If there are more than one such destination, remove all but one of them. Also, remove any interfaces that have no destinations.

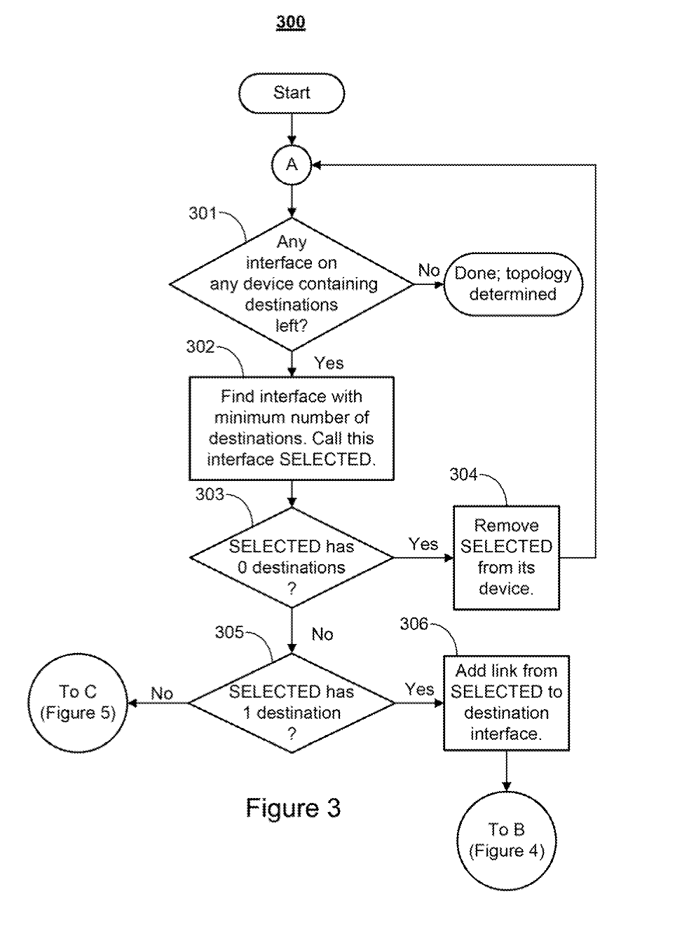

The flowcharts in FIGS. 3 through 5 show how links are determined in a topology. The flowcharts describe the iterations discussed above with respect to examples 1 and 2. Connections and unknown domains are calculated. In each iteration of the loop, a link determined from the connections or an unknown domain that most improves the topology is added. As links and unknown domains are added to the output, destinations, interfaces, and devices that are no longer needed are removed from the connection data used as inputs to the processing. To maintain consistency of the inputs the following tasks are performed. Whenever a destination B is removed from Interface A, the destination A on Interface B is removed as well (all communication is two way). Whenever an interface is removed, all the destinations to that interface are removed. Whenever a device is removed, all its interfaces are removed.

A set of candidate selections of links in use for network interfaces of network devices in the network is determined. This may include connection data that has been standardized and/or normalized. As shown in the methods 300-500 in FIGS. 3-5, links are determined for each of the network interfaces. As shown in the flowchart 300, the order for determining links for interfaces may be based on the number of connections. Interfaces with the least number of connections are selected first. The methods 300 through 500 are described with respect to being performed by the topology generator 101 shown in FIG. 1 by way of example and not limitation.

As shown in FIG. 3 for the method 300, at 301, the topology generator 101 determines if there is any interface on any device containing a destination based on connection data determined for a network. For example, table 4 described above includes the connection data for a network. Starting with table 4 before any iteration is performed, each interface has a destination, so processing continues to 302.

At 302, the topology generator 101 finds an interface with a minimum number of destinations. This interface is referred to as the SELECTED interface. In example 1, the interface B-1 is SELECTED. The destination interface for SELECTED is REVERSE. The SELECTED device is BEGIN, and the REVERSE device is END.

At 303, the topology generator 101 determines if SELECTED interface has 0 destination interfaces (i.e., destinations). If yes, SELECTED is removed from the connection data at 304. Removing SELECTED from the connection data means that the interface is considered not to be part of any connections that can be selected as a link in the topology based on the current processing. In other words, connections for the removed interfaces may no longer be part of candidate links that can be selected for inclusion in the topology. Removing may include marking, flagging or indicating through another way that the interface may not be used to identify other links in the topology when performing the iterations. SELECTED, however, may not actually be deleted from the data storage, and may be used in future processing to determine links for the topology.

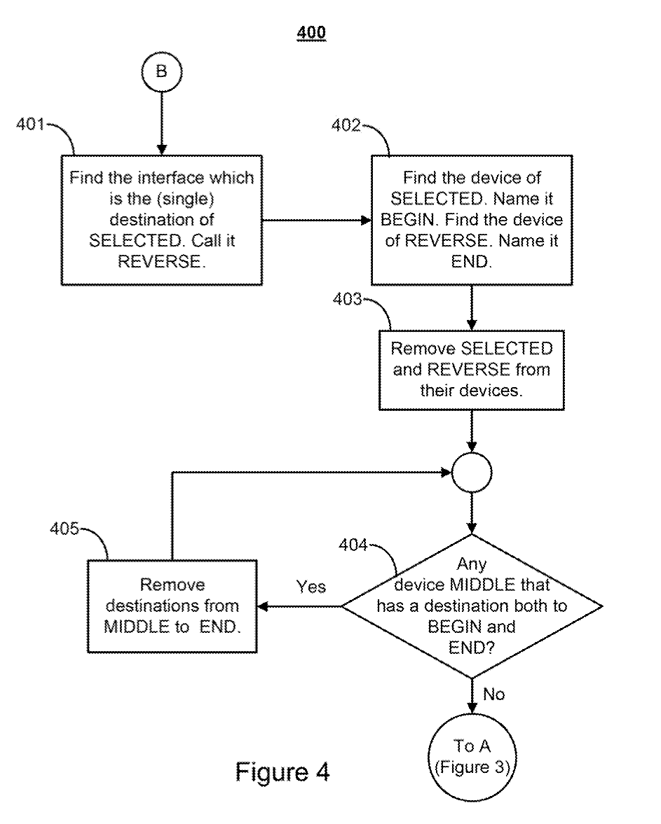

If no at 303, the topology generator 101 determines if SELECTED has 1 destination interface at 305. If yes, a link is added to the topology between SELECTED and REVERSE, which is the destination interface, at 306. This process is also described with respect to example 1 above. For example, a link is added from B-1 to C-1 in the first iteration of example 1. In the first iteration SELECTED=B-1 and REVERSE=C-1. After 306, processing proceeds to the method 400 shown in FIG. 4.

At 401, the topology generator 101 identifies REVERSE. For example, REVERSE=C-1 in the first iteration of example 1. At 402, the topology generator 101 identifies the device for selected (i.e., BEGIN) and the device for REVERSE (i.e., END). For example, in the first iteration of example 1. BEGIN=B, and END=C.

At 403, the topology generator 101 removes SELECTED and REVERSE from their devices in the connection data. At 404, the topology generator 101 determines if there are any devices that have a destination to both BEGIN and END. These devices are each referred to as MIDDLE. If yes, the topology generator 101 removes destinations from MIDDLE to END at 405. For example, in iteration 1 destinations A-1, B-1, D-1, and E-1 are removed from C-1, and the corresponding reverse links. In addition, interfaces B-1 and C-1 are removed. If no at 404, processing proceeds back to the method 300 as shown.

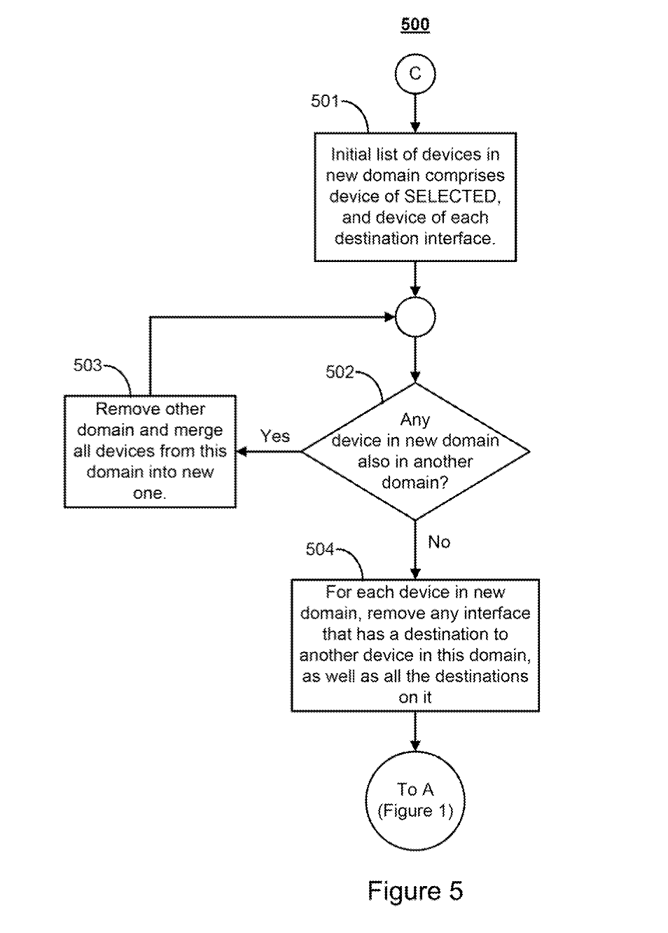

At 305 in the method 300, if SELECTED is determined to have more than one destination, then processing proceeds to the method 500 shown in FIG. 5. In the method 500 a new domain, called unknown domain, may be added and removal of unneeded destinations may be performed. This is further described above with respect to example 2. For example, in example 2, as described with respect to iteration 2, A-1 has two destinations and all remaining interfaces have two destinations. At 501, the topology generator determines a list of devices including the device of SELECTED (i.e., BEGIN) and the device of each destination interface if SELECTED. These devices are connected to the unknown domain. For example, in iteration 2, the device containing A-1, and the devices containing destinations of A-1 (namely C and D) are identified. These devices (e.g., A, C and D) are connected to an unknown domain, which is added to the topology. If any devices in the new domain are part of another domain, then the other domain may be removed, and all members of the other domain are moved to the unknown domain at 502 and 503. In other words, if the new unknown domain overlaps with an old one, the domains get merged into one large domain comprising all the devices in both. Also, all destinations between interfaces on devices in the new domain are removed at 504. For example, all destinations for interfaces on A, C, and D are removed.

The methods 300 through 500 may be performed in a single iteration. Then, the iteration is repeated until there are no interfaces on any devices containing a destination, such as shown at 301 which goes to DONE if no at 301. Each iteration either adds a link or an unknown domain and may remove either one or more destinations, and/or one or more interfaces as described. The number of loops may be proportional to the number of connections and unknown domains found—which is in turn proportional to the number of network devices, since layer 2 devices are connected via a spanning tree. In a switched Ethernet network with complete information, the discovery process produces a spanning tree solution which corresponds to the actual spanning tree in the network.

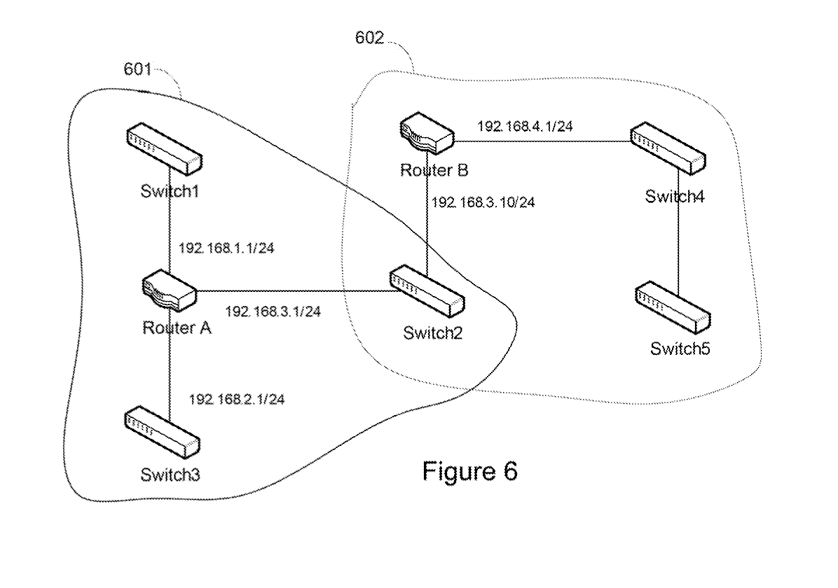

The topology discovery process can be performed in layer 2 networks. The process may also be performed for layer 3 IP networks, as is shown in FIG. 6. The topology discovery process is run once for each router over devices that have IP addresses supported by the IP address ranges supported by the router's interfaces. Then the union of the results of the topology discovery processes is taken. Where the IP domains of routers intersect (e.g., the intersections of domains 601 and 602), connections are normally the same for each router. Unknown domains may differ. For example, if two unknown domains contain the same device, they may be replaced by a single unknown domain containing all the devices in the two domains.

The topology discovery process described above can generate the topology even if complete information is not available. If partial information is provided, the process provides accurate network connections at least in parts of the network where sufficient information is available. Also, it identifies unknown domains for which additional information is needed.

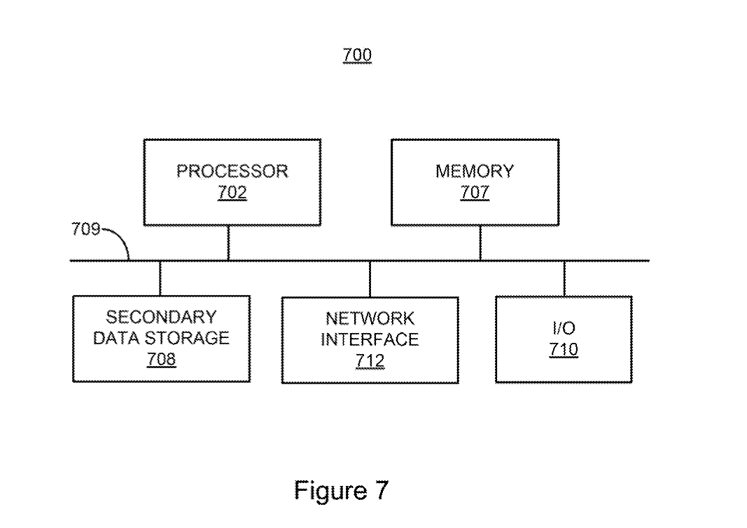

FIG. 7 shows a computer system 700 that may be used with the embodiments described herein. The computer system 700 represents a generic platform that includes components that may be in a server or another computer system. The computer system 700 may be used as a platform for the topology generator 101 and/or other components described herein. The computer system 700 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 700 includes a processor 702 that may implement or execute machine readable instructions performing some or all of the methods, functions and other processes described herein. Commands and data from the processor 702 are communicated over a communication bus 709. The computer system 700 also includes a main memory 707, such as a random access memory (RAM), where the machine readable instructions and data for the processor 702 may reside during runtime, and a secondary data storage 708, which may be non-volatile and stores machine readable instructions and data. The memory and data storage are examples of computer readable mediums.

The computer system 700 may include an I/O device 710, such as a keyboard, a mouse, a display, etc. The computer system 700 may include a network interface 712 for connecting to a network. Other known electronic components may be added or substituted in the computer system 700.

While the embodiments have been described with reference to examples, various modifications to the described embodiments may be made without departing from the scope of the claimed embodiments.

What is claimed is:

1. A method for topology discovery for network devices in a network, the method comprising;
identifying the network devices in the network;
determining connection data identifying connections between the network devices, the connection data including, for each network device, an interface ID for each network interface on the network device and a destination ID for each destination network interface that is a destination of an interface on the network device;
performing, by a processor, iterations to determine links in the topology based on the connection data, wherein each iteration comprises
adding a link (306) in the topology from a selected network interface identified in the connection data to a destination network interface identified in the connection data if the selected network interface has one destination interface in the connection data;
adding an unknown domain (501) to the topology if the selected network interface has y number of destination interfaces in the connection data, where y>1; and
removing an interface (403) associated with the added link from the connection data if the link is added to the topology; and
determining the topology from the iterations.

2. The method of claim 1, wherein adding a link in the topology comprises:
identifying an interface in the connection data having a minimum number of destinations (302), wherein the identified interface is the selected network interface;
determining if the selected network interface has only one destination interface in the connection data (305); and
if the selected network interface has only one destination interface, adding the link from the selected network interface to its destination interface (306).

3. The method of claim 1, wherein a network device having the selected interface is a begin device, and removing an interface associated with the added link comprises:
determining a reverse interface (401) from the connection data, wherein the reverse interface is a destination interface of the selected network interface and a network device having the reverse, interface is an end device;
removing the selected network interface (403) from the begin device in the connection data;
removing the reverse interface from the end device (403) in the connection data;
determining if there are any middle devices (404) from the connection data, wherein a middle device has a destination to both the begin device and the end device; and
for each middle device, remove any destinations from the middle device to the end device (405).

4. The method of claim 1, wherein adding an unknown domain to the topology comprises:
if all the network interfaces each has more than one destination interface in the connection data, adding the unknown domain to the topology (501); and
adding a link in the topology to the unknown domain from the selected network interface (501); and
adding a link in the topology from each network device connected to the selected network interface to the unknown domain as determined from the connection data (501).

5. The method of claim 4, comprising:
determining if any devices connected to the unknown do in are also connected to another unknown domain in the topology (502); and
combining the unknown domain and the another unknown domain into a single unknown domain if any devices connected to the unknown domain are also connected to the another unknown domain (503).

6. The method of claim 1, wherein determining connection data identifying connections between the network devices comprises:
polling the network devices for connection data identifying, for each of the network interfaces in the network devices, an address for any network interface in the network potentially connected to the network interface; and
normalizing the connection data.

7. The method of claim 1, wherein the connection data comprises data from at least one of MAC and ARP caches in the network devices.

8. The method of claim 1, wherein each link in the topology comprises a direct link and is bi-directional.

9. The method of claim 1, wherein each link in the topology comprises a direct link between two of the network interfaces on two of the network devices.

10. A non-transitory computer readable medium (707) including machine readable instructions that when executed by a processor (702) perform instructions to:
identify network devices in a network;
determine connection data identifying connections between the network devices, the connection data including, for each network device, an interface ID for each network interface on the network device and a destination ID for each destination network interface that is a destination of an interface on the network device;
perform iterations to determine links in the topology based on the connection data, wherein each iteration comprises
adding a link (306) in the topology from a selected network interface identified in the connection data to a destination network interface identified in the connection data if the selected network interface has one destination interface in the connection data;
adding an unknown domain (501) to the topology if the selected network interface has y number of destination interfaces in the connection data, where y>1; and
removing an interface (403) associated with the added link from the connection data if the link is added to the topology; and
determine a topology of the network from the iterations.

11. The non-transitory computer readable medium of claim 10, wherein adding a link in the topology comprises:
identifying an interface in the connection data having a minimum number of destinations (302), wherein the identified interface is the selected network interface;
determining if the selected network interface has only one destination interface in the connection data (305); and
if the selected network interface has only one destination interface, adding the link from the selected network interface to its destination interface (306).

12. The non-transitory computer readable medium of claim 10, wherein a network device having the selected interface is a begin device, and removing an interface associated with the added link comprises:
determining a reverse interface (401) from the connection data, wherein the reverse interface is a destination interface of the selected network interface and a network device having the reverse interface is an end device;
removing the selected network interface (403) from the begin device in the connection data;
removing the reverse interface from the end device (403) in the connection data;
determining if there are any middle devices (404) from the connection data, wherein a middle device has a destination to both the begin device and the end device; and
for each middle device, remove any destinations from h middle device to the end device (405).

13. The non-transitory computer readable medium of claim 10, wherein adding an unknown domain to the topology comprises:
if all the network interfaces each has y number of destination interfaces in the connection data, adding the unknown domain to the topology (501); and
adding a link in the topology to the unknown domain from the selected network interface (501); and
adding a link in the topology from each network device connected to the selected network interface to the unknown domain as determined from the connection data (501).

14. The non-transitory computer readable medium of claim 13, wherein the instructions comprise instructions to:
determine if any devices connected to the unknown do also connected to another unknown domain in the topology (502); and
combine the unknown domain and the another unknown domain into a single unknown domain if any devices connected to the unknown domain are also connected to the another unknown domain (503).

15. A computer system (700) comprising:
data storage (707, 708) to store connection data identifying connections between network devices in a network, the connection data including, for each network device, an interface ID for each network interface on the network device and a destination ID for each destination network interface that is a destination of an interface on the network device; and
a processor (702) to determine a topology of the network by performing iterations to determine links in the topology based on the connection data, wherein each iteration comprises
adding a link in the topology from a selected network interface identified in the connection data to a destination network interface identified in the connection data if the selected network interface has one destination interface in the connection data;
adding an unknown domain to the topology if the selected network interface has y number of destination interfaces in the connection data, where y>1; and
removing an interface associated with the added link from the connection data if the link is added to the topology.
